(19) United States
(12) Patent Application Publication
(10) Pub. No.: US 2008/0263388 A1
(43) Pub. Date: Oct. 23, 2008

(54) METHOD AND APPARATUS FOR MANAGING CUSTOMER TOPOLOGIES

(76) Inventors: JAMES ROBERT ALLEN, Garner, NC (US); John Andrew Canger, Lake Zurich, IL (US); Chin-Wang Chao, Lincroft, NJ (US); Donald Howard Esry, Chapel Hill, NC (US); Cynthia R. Hoppe, Algonquin, IL (US); Wenwen Ji, Cedar Knolls, NJ (US); Angelo Napoli, Princeton, NJ (US); Ronald Papritz, Amityville, NJ (US)

Correspondence Address: AT&T CORP., ROOM 2A207, ONE AT&T WAY, BEDMINSTER, NJ, 07921, US

(21) Appl. No.: 11/737,027

(22) Filed: Apr. 18, 2007

(51) Int. Cl. G06F 11/18

(52) U.S. Cl. 714/4

(57) ABSTRACT

A method and apparatus for managing customer topologies on packet networks are disclosed. For example, the method creates at least two event correlation instances for at least one customer topology, where a first event correlation instance resides in a primary availability management server, and a second event correlation instance resides in a secondary availability management server. The method also creates a test node for the first event correlation instance, where the test node provides at least one test message. The method then receives at least one response generated by the first event correlation instance that is responsive to the at least one test message, where the at least one response is received by the second event correlation instance. The method then performs a fail-over to the second event correlation instance from the first event correlation instance if a failure is detected from the at least one response.

The present invention relates generally to communication networks and, more particularly, to a method and apparatus for managing customer topologies on packet networks, e.g., Internet Protocol (IP) networks, managed Virtual Private Networks (VPN), etc.

### BACKGROUND OF THE INVENTION

An enterprise customer may build a Virtual Private Network (VPN) by connecting multiple sites or users over a network from a network service provider. The enterprise VPN may be managed either by the customer or the network service provider. The cost of managing a VPN by a customer is often prohibitive since dedicated networking expertise and network management systems are required. Hence, more and more enterprise customers are asking their network service provider to manage their VPNs. The network service provider often deploys a primary and a backup availability management server for redundancy. When a failure occurs in the primary server, a fail-over is performed to the back-up server. Since, the servers are being used for availability management of multiple VPNs, the fail-over will affect multiple VPNs and/or multiple customers. However, the actual failure in the primary server might have only affected only one VPN and/or customer.

Therefore, there is a need for a method that provides management of customer topologies.

### SUMMARY OF THE INVENTION

In one embodiment, the present invention discloses a method and apparatus for managing customer topologies on packet networks, e.g., Internet Protocol (IP) networks, managed Virtual Private Networks (VPN), etc. For example, the method creates at least two event correlation instances for at least one customer topology, where a first event correlation instance of the at least two event correlation instances resides in a primary availability management server, and where a second event correlation instance of the at least two event correlation instances resides in a secondary availability management server. The method also creates a test node for the first event correlation instance, where the test node provides at least one test message. The method then receives at least one response generated by the first event correlation instance that is responsive to the at least one test message, where the at least one response is received by the second event correlation instance. The method then performs a fail-over to the second event correlation instance from the first event correlation instance if a failure is detected from the at least one response.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network for managing customer topologies;

FIG. 3 illustrates a flowchart of a method for managing customer topologies; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for managing one or more customer topologies on packet networks. Although the present invention is discussed below in the context of IP networks, the present invention is not so limited. Namely, the present invention can be applied to other networks.

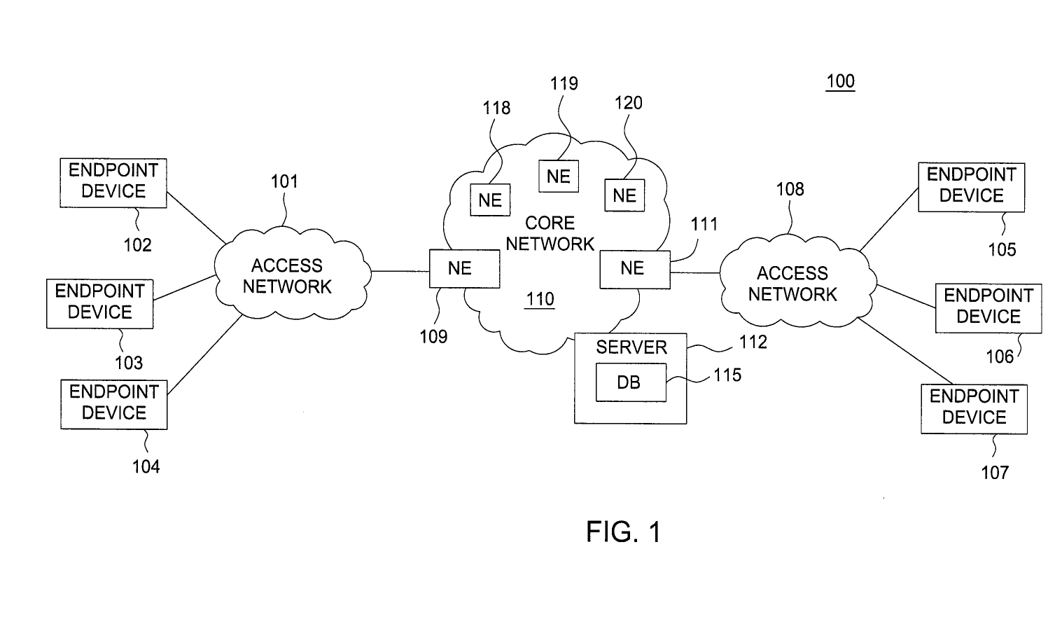

FIG. 1 is a block diagram depicting an exemplary packet network 100 related to the current invention. Exemplary packet networks include Internet protocol (IP) networks, Asynchronous Transfer Mode (ATM) networks, frame-relay networks, and the like. An IP network is broadly defined as a network that uses Internet Protocol such as IPv4 or IPv6 to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110. Those skilled in the art will realize that although only six endpoint devices, two access networks, and five network elements (NEs) are depicted in FIG. 1, the communication system 100 may be expanded by including additional endpoint devices, access networks, and border elements without limiting the scope of the present invention.

The endpoint devices 102-107 may comprise customer endpoint devices such as personal computers, laptop computers, Personal Digital Assistants (PDAs), servers, and the like. The access networks 101 and 108 serve as a means to establish a connection between the endpoint devices 102-107 and the NEs 109 and 111 of the core network 110. The access networks 101, 108 may each comprise a Digital Subscriber Line (DSL) network, a broadband cable access network, a Local Area Network (LAN), a Wireless Access Network (WAN), and the like. Some NEs (e.g., NEs 109 and 111) reside at the edge of the core infrastructure and interface with customer endpoints over various types of access networks. An NE that resides at the edge of the core infrastructure is typically implemented as an edge router, a media gateway, a border element, a firewall, a switch, and the like. An NE may also reside within the network (e.g., NEs 118-120) and may be used as a honeypot, a mail server, a router, an application server, or like device. The core network 110 also comprises an application server 112 that contains a database 115. The application server 112 may comprise any server or computer that is well known in the art, and the database 115 may be any type of electronic collection of data that is also well known in the art.

The above IP network is described to provide an illustrative environment in which packets for voice and data services are transmitted on networks. Since Internet services are becoming ubiquitous, more and more businesses and consumers are relying on their Internet connections for both voice and data transport needs. For example, an enterprise customer may build a Virtual Private Network (VPN) by connecting multiple sites or users over either a public network or a network of a network service provider.

The enterprise VPN may be managed either by the customer or the network service provider. The cost of managing a VPN by a customer is extensive since this approach does not facilitate sharing of networking expertise and/or network management systems across multiple enterprises. Hence, more and more enterprise customer VPNs are being managed by the network service providers. The network service provider reduces the cost of managing VPNs by managing multiple VPNs using the same network management systems and/or expertise.

For example, the network service provider may use an off-the-shelf availability manager, e.g., EMC's Smarts InCharge. Furthermore, the network service provider often deploys a primary and a backup availability management server for redundancy. When a failure occurs in the primary server being used for availability management, a fail-over is performed to the back-up server. Since the servers are being used for availability management of multiple VPNs, the fail-over affects multiple VPNs and most likely multiple customers. However, the actual failure in the primary server might have affected only one VPN and/or customer. Furthermore, as the number of VPNs being managed with the same servers increases, the probability of having a failure that affects at least one of the VPNs increases. As the probability of having a failure that affects at least one of the VPNs increases, the number of fail-over attempts in a given time as well as the probability of both the primary and the back-up servers being affected by some type of failure will increase. Therefore, there is a need for a method that provides management of customer topologies.

In one embodiment, the current invention provides management of customer topologies (e.g., customer network topologies) by using multiple event correlation instances for multiple topologies. An event correlation instance contains an instance of an availability management system and a notification adaptor for the instance of the availability management system. For example, an event correlation instance may be created for each enterprise customer or each VPN.

The notification adaptor for an instance of the availability management system may comprise: a customized code for filtering out unwanted IP addresses, a customized code for performing polling, e.g., time-of-day and frequency, a customized code for performing fail-over per an instance of said availability management system (as opposed to failing over an entire server), or a customized code for enabling an automatic and/or manual return to the primary server.

In one embodiment, the current invention provides a script that simulates a test node as being “up” or “down” on a regular interval to determine the aliveness of the notification adaptor for the purpose of performing the fail-over function. For example, the test node is designed to imitate a customer premise equipment (CPE) device. It should be noted that although the test node is illustrated as being deployed on the primary availability management server, the present invention is not so limited. For example, the test node can be deployed external to the primary availability management server. In one exemplary embodiment, the notification adaptor is placed on a backup availability management server. A test node that goes “up” or “down” is created for each event correlation instance in the primary availability management server. The notification adaptor located in the backup availability management server attaches to one or more event correlation instances in a primary availability management server and subscribes to messages for only the test nodes. If a response is not received for “N” consecutive test messages for a test node, then the notification adaptor performs the fail-over for the event correlation instance associated with the test node. As such, the term “response” in the present invention may broadly include a lack of a response depending on the specific implementation of the present invention.

In one embodiment, “N” is a tunable parameter. In another embodiment, “N” is a static value determined by the network service provider. Note that the success or failure of test messages is determined using data for recent disconnects and the age of the previous test message. For example, a topology change may have occurred since the previous test message.

In one embodiment, the current invention provides a seed-file distribution server to push down topology and configuration changes from a provisioning system to servers being used for availability management. For example, a service provider may have 10 primary and 10 backup availability management servers managing VPNs based on physical location (e.g., regions). When a topology change is made through a provisioning system, the provisioning system may provide updates to the seed-file distribution server. The seed-file distributor may then determine the primary and back-up availability management servers that are affected by the changes and pushes down the topology and configuration changes to the appropriate servers. For example, changes to topology such as add, delete, modify may be made and distributed regularly as delta (change) files to the primary and secondary availability management systems and the affected event correlation instances. In one embodiment, the seed-file distribution server may also interface with manual input systems to push down manually entered updates to availability management servers.

In one embodiment, the current invention provides a topology synchronization adaptor in the primary or backup availability management server to synchronize the topology data in the primary and backup servers. For example, the topology synchronization adaptor may match topology data for each event correlation instance, in a pre-determined schedule, to ensure the data in the primary and backup availability management servers are the same. For example, after a provisioning change, if the seed-file distributor has performed updates only in the primary system, the backup server topology may not be synchronized with that of the primary system during a fail-over. Hence, the topology synchronization adaptor may be used to ensure proper operation during a fail-over.

In one embodiment, the current invention provides a smoothing interval for the availability management systems to increase the fault tolerance of the availability management systems. For example, a customized smoothing interval may be used to control how faults are determined and reported based on time-of-day to reduce pre-mature fault ticketing. A different smoothing interval may be needed for different levels of fault management provided during different time periods. For example, a utilization level of 95% may require ticketing for a specific time of day but while it may be acceptable in another time of day. The smoothing interval may also be variable based on the event correlation instance. For example, an event correlation instance for a customer VPN may have a different fault tolerance from that of another customer VPN.

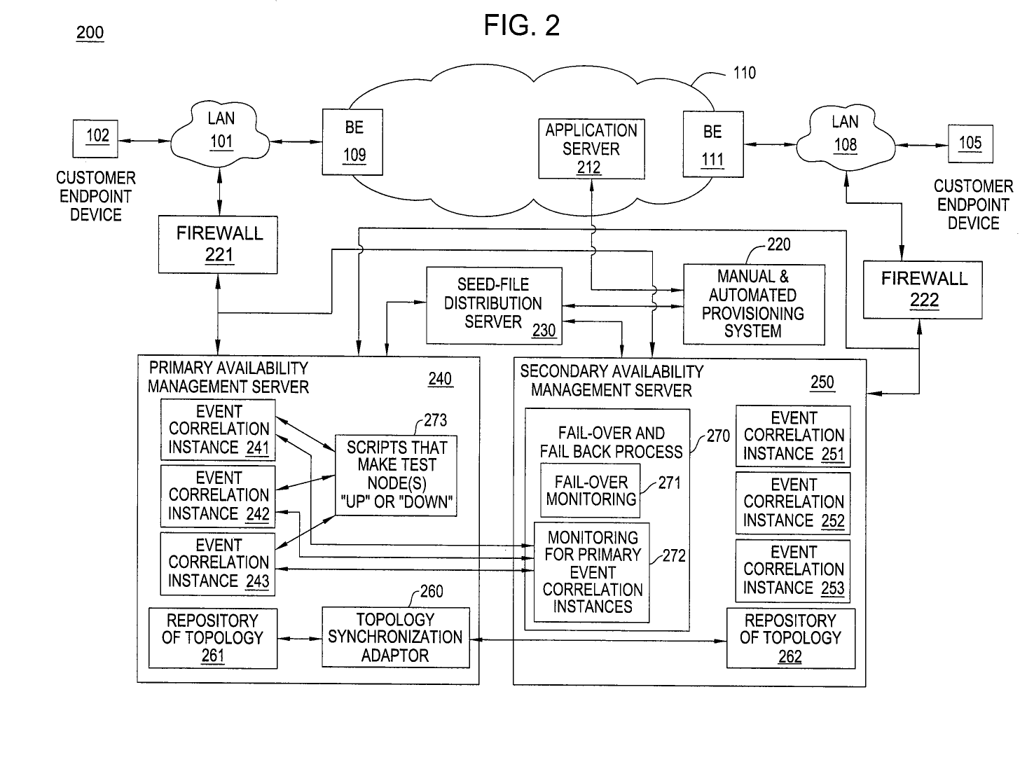

FIG. 2 illustrates an exemplary network 200 for managing customer topologies. For example, a customer endpoint device 102 is connected to a local access network 101 to send and receive packets to and from customer endpoint device 105 connected to local access network 108. Local access network 101 is connected to an IP/MPLS core network 110 through border element 109. Local access network 108 is connected to the IP/MPLS core network 110 through border element 111.

In one embodiment, the network service provider enables customers to interact and subscribe to a service for management of customer networks in application server 212 in the IP/MPLS core network 110. For example, an enterprise customer may subscribe to have its VPN be managed by the network service provider. The application server 212 is connected to a provisioning system 220. The provisioning system 220 is connected to a seed-file distribution server 230. In one embodiment, the seed-file distribution server 230 is connected to a primary availability management server 240 and a secondary (backup) availability management system 250. The primary availability management server 240 contains a module 273 for executing scripts that make or simulate test node(s) as being “up” or “down”, event correlation instances 241-243, a repository of topology 261, and a topology synchronization adaptor 260. The secondary (backup) availability management server 250 contains a module 270 for performing a fail-over and fail-back process, event correlation instances 251-253, and a repository of topology 262.

In one embodiment, the LAN 101 can be deployed in a manner such that it is in communication with the primary availability management server 240 and the secondary availability management server 250 via a firewall 221. Similarly, the LAN 108 can be deployed in a manner such that it is in communication with the primary availability management server 240 and the secondary availability management server 250 via a firewall 222. This arrangement allows events to be communicated to the primary and secondary availability management servers 240 and 250.

In one embodiment, the fail-over and fail-back module 270 contains a module 271 for monitoring the fail-over process and a module 272 for monitoring of the event correlation instances 241-243 located in the primary availability management server 240. The module 272 is in communication with the event correlation instances 241-243. For example, the module 272 receives actual events destined for the event correlation instances 241-243. It also receives responses to test messages for test nodes established for the event correlation instances 241-243.

In one embodiment, the topology synchronization adaptor 260 synchronizes the contents of the topology repositories 261 and 262 periodically to ensure the latest topology is available on both the primary and backup availability management servers 240 and 250. When a provisioning update is performed via provisioning system 220, the update is provided to seed-file distributor 230. The seed-file distributor 230 determines the affected availability management servers and event correlation instances in those servers, and pushes down the updates to the affected components.

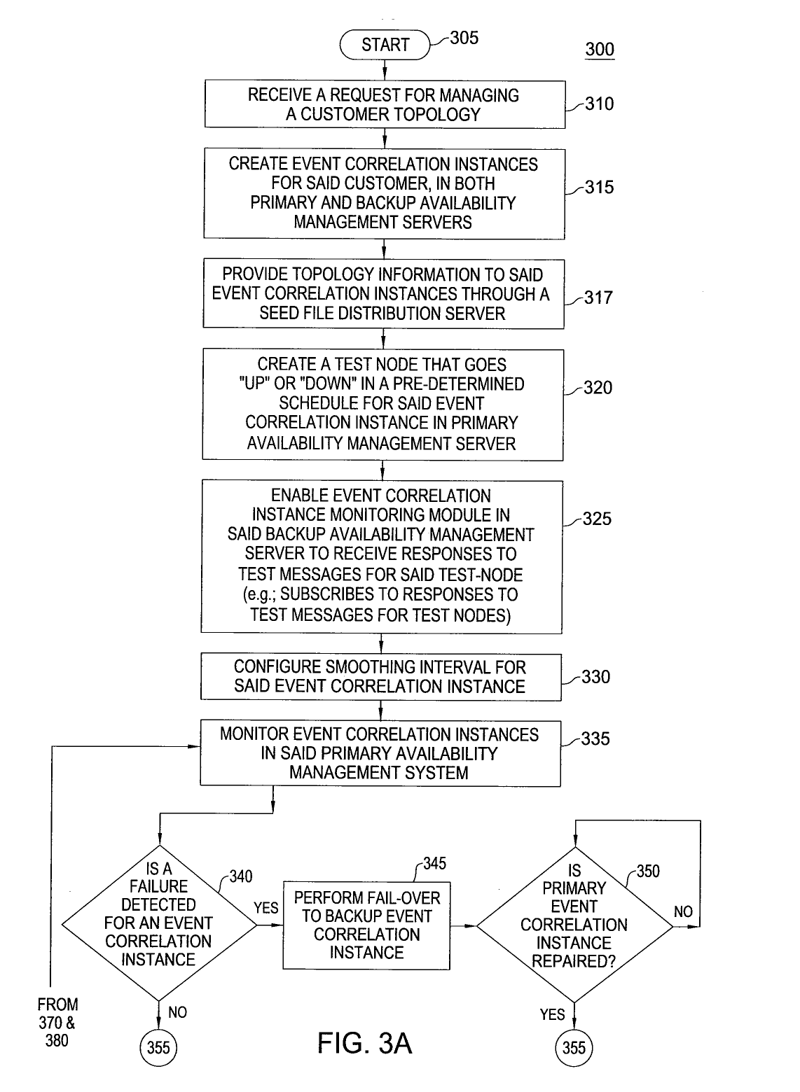

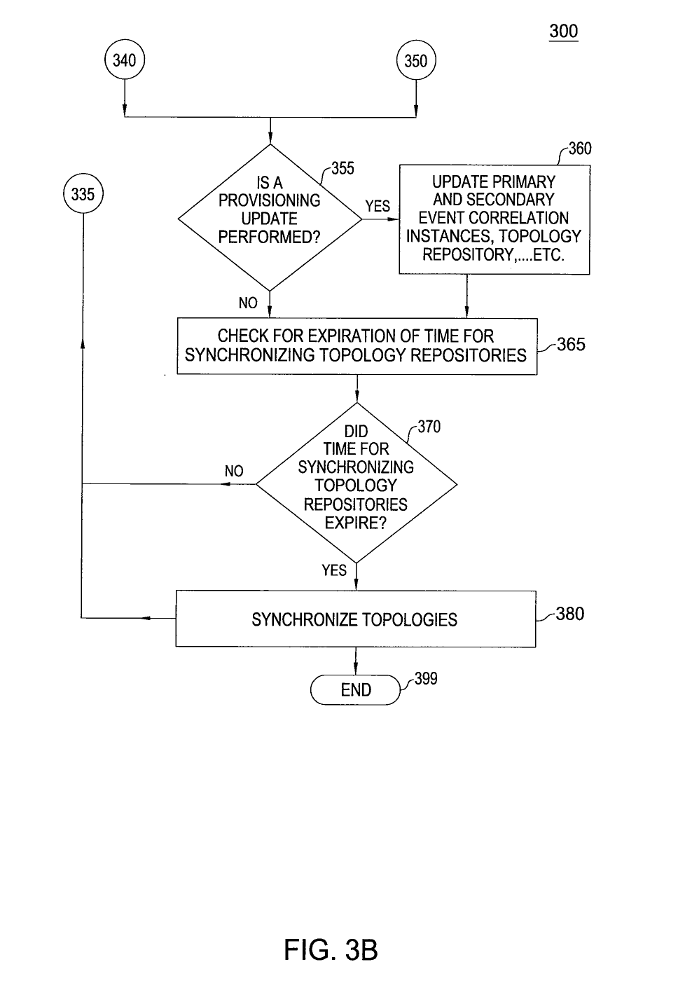

FIG. 3 illustrates a flowchart of a method 300 for managing customer topologies. Method 300 starts in step 305 and proceeds to step 310.

In step 310, method 300 receives a request for managing of a customer topology. For example, an enterprise customer may subscribe to have its VPN managed by the network service provider.

In step 315, method 300 creates at least a pair of event correlation instances for the customer, one in each of a primary availability management server and a backup (secondary) availability management server.

In step 317, method 300 provides topology information to said event correlation instances through a seed-file distribution server. For example, a provisioning system may provide a master topology file to the seed-file distribution server. The seed-file distribution server may then forward the received topology data (or updates) to the event correlation instances.

In step 320, method 300 creates a test node that goes “up” or “down” in a pre-determined schedule for the event correlation instance in the primary availability management server. For example, a test node that imitates a CPE location may be created and the test node may be failed and recovered periodically to imitate failure and restoration.

In step 325, method 300 enables the event correlation instance module in the backup availability management server to receive responses to test messages for the test node. For example, the backup server subscribes to test messages for event correlation instances that the backup server is providing fail-over functionality.

In step 330, method 300 may configure a smoothing interval for each of the event correlation instances. For example, an alarm or a ticket may be generated only if a failure is detected in “n” consecutive intervals with each interval being “x” number of seconds, and so on.

In step 335, method 300 monitors event correlation instances in the primary availability management system. For example, the module for monitoring event correlation instances (located in the backup server) receives “fault messages” and “responses to test messages” for event correlation instances in the primary server.

In step 340, method 300 determines whether or not a failure is detected for an event correlation instance. If a failure is detected, the method proceeds to step 345. Otherwise, the method proceeds to step 355.

In step 345, method 300 performs fail-over to the backup event correlation instance for the failed event correlation instance in the primary server. Note that the fail-over is performed per event correlation instance as opposed to fail-over of an entire server. The method then proceeds to step 350.

In step 350, method 300 determines whether or not the primary event correlation instance is repaired. For example, the server continues to receive test messages until the trouble is fixed. If the trouble clears, the method proceeds to step 355. Otherwise, the method continues to check until it clears.

In step 355, method 300 determines whether or not a provisioning update is performed. For example, a topology change might be received through the seed-file distributor server. If a provisioning update is received, the method proceeds to step 360. Otherwise, the method proceeds to step 365.

In step 360, method 300 updates primary and backup event correlation instances, topology repositories, etc. in accordance with the provisioning updates. The method then proceeds to step 365.

In step 365, method 300 checks for expiration of time for synchronizing the topology repositories. For example, the topology repositories may be updated on a hourly basis.

In step 370, method 300 determines whether or not the time for synchronization of the repositories has expired. If the time has expired, the method proceeds to step 380 to synchronize the topology repositories. Otherwise, the method proceeds to step 335 to continue monitoring event correlation instances.

In step 380, method 300 synchronizes the topologies in the primary and backup servers and proceeds to step 399 to end the current process or to return to step 335 to continue monitoring event correlation instances.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

Those skilled in the art would realize that the various systems or servers for provisioning, seed-file distribution, availability management, interacting with the customer, and so on may be provided in separate devices or in one device without limiting the present invention. As such, the above exemplary embodiment is not intended to limit the implementation of the current invention.

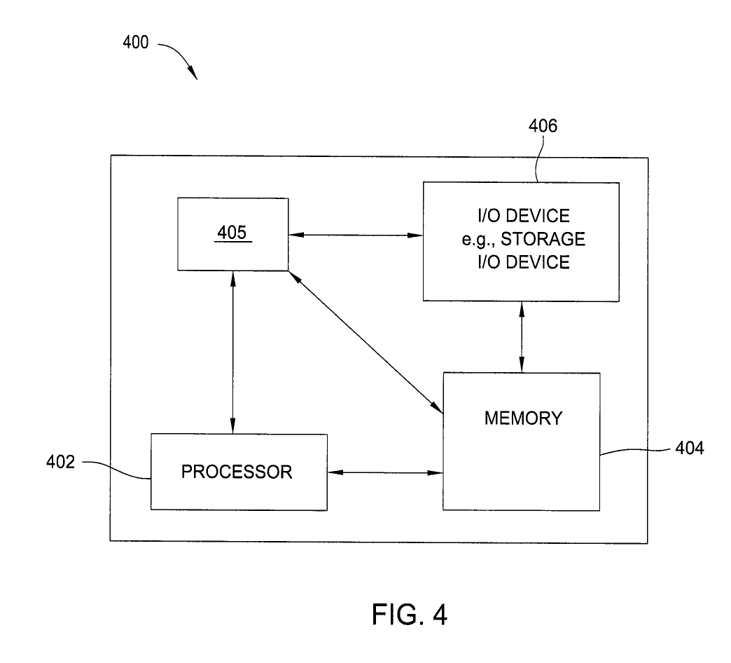

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for managing one or more customer topologies, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for managing one or more customer topologies can be loaded into memory 404 and executed by processor 402 to implement the functions as discussed above. As such, the present method 405 for managing one or more customer topologies (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for managing at least one customer topology, comprising:
creating at least two event correlation instances for said at least one customer topology, where a first event correlation instance of said at least two event correlation instances resides in a primary availability management server, and where a second event correlation instance of said at least two event correlation instances resides in a secondary availability management server;
creating a test node for said first event correlation instance, where said test node provides at least one test message;
receiving at least one response generated by said first event correlation instance that is responsive to said at least one test message, where said at least one response is received by said second event correlation instance; and
performing a fail-over to said second event correlation instance from said first event correlation instance if a failure is detected from said at least one response.

2. The method of claim 1, wherein customer topology information is provided to said first event correlation instance and said second event correlation instance.

3. The method of claim 2, further comprising:
storing said customer topology information in a first repository in said primary availability management server; and
storing said customer topology information in a second repository in said secondary availability management server.

4. The method of claim 3, further comprising:
updating said first and said second event correlation instances and said first and second repositories when a provisioning update is received.

5. The method of claim 3, further comprising:
synchronizing said first and said second repositories periodically.

6. The method of claim 1, wherein said failure is detected in accordance with a smoothing interval.

7. The method of claim 1, wherein said test node simulates a customer premise equipment (CPE) device.

8. The method of claim 7, wherein said at least one test message simulates whether said CPE device is “up” or “down”.

9. The method of claim 1, further comprising:
performing a fail-over from said second event correlation instance to said first event correlation instance if said failure is no longer detected.

10. A computer-readable medium having stored thereon a plurality of instructions, the plurality of instructions including instructions which, when executed by a processor, cause the processor to perform the steps of a method for managing at least one customer topology, comprising:
creating at least two event correlation instances for said at least one customer topology, where a first event correlation instance of said at least two event correlation instances resides in a primary availability management server, and where a second event correlation instance of said at least two event correlation instances resides in a secondary availability management server;
creating a test node for said first event correlation instance, where said test node provides at least one test message;
receiving at least one response generated by said first event correlation instance that is responsive to said at least one test message, where said at least one response is received by said second event correlation instance; and
performing a fail-over to said second event correlation instance from said first event correlation instance if a failure is detected from said at least one response.

11. The computer-readable medium of claim 10, wherein customer topology information is provided to said first event correlation instance and said second event correlation instance.

12. The computer-readable medium of claim 11, further comprising:
storing said customer topology information in a first repository in said primary availability management server; and
storing said customer topology information in a second repository in said secondary availability management server.

13. The computer-readable medium of claim 12, further comprising:
updating said first and said second event correlation instances and said first and second repositories when a provisioning update is received.

14. The computer-readable medium of claim 12, further comprising:
synchronizing said first and said second repositories periodically.

15. The computer-readable medium of claim 10, wherein said failure is detected in accordance with a smoothing interval.

16. The computer-readable medium of claim 10, wherein said test node simulates a customer premise equipment (CPE) device.

17. The computer-readable medium of claim 16, wherein said at least one test message simulates whether said CPE device is “up” or “down”.

18. The computer-readable medium of claim 10, further comprising:
performing a fail-over from said second event correlation instance to said first event correlation instance if said failure is no longer detected.

19. A system for managing at least one customer topology, comprising:
a primary availability management server having a first event correlation instance for said at least one customer topology;
a secondary availability management server having a second event correlation instance for said at least one customer topology; and
a test node for said first event correlation instance, where said test node provides at least one test message, wherein at least one response generated by said first event correlation instance that is responsive to said at least one test message is received by said second event correlation instance, and wherein said first event correlation instance fail-overs to said second event correlation instance if a failure is detected from said at least one response.

20. The system of claim 19, wherein customer topology information is provided to said first event correlation instance and said second event correlation instance.
